(19) United States
(12) Patent Application Publication
(10) Pub. No.: US 2002/0004141 A1
(43) Pub. Date: Jan. 10, 2002

(54) Magnet and process for its production

(76) Inventors: Peter Schrey, Seeheim-Jugenheim (DE); Wilhelm Fernengel, Kleinostheim (DE); Lothar Zapf, Alzenau (DE)

Correspondence Address: JOHN S. PRATT, ESQ, KILPATRICK STOCKTON, LLP, 1100 PEACHTREE STREET, SUITE 2800, ATLANTA, GA, 30309, US

(21) Appl. No.: 09/861,311

(22) Filed: May 18, 2001

(30) Foreign Application Priority Data
May 23, 2000 (DE) 100 25 458.6

(51) Int. Cl. B22F 3/24; B22F 7/04; H01F 1/053; H01F 1/08

(52) U.S. Cl. 428/548; 428/567; 419/29; 419/8; 419/46; 428/611; 148/537

(57) ABSTRACT

The magnet has hard magnetic grains (K), with the hard magnetic grains (K) separated from one another in a surface layer of the magnet by a first phase (P1), while the hard magnetic grains (K) in the remaining part of the magnet are separated from one another through a nonmagnetic second phase (P2). The first phase (P1) is more corrosion resistant than the second phase (P2), so that the surface layer serves as corrosion protection. The first phase (P1) has, in addition to elements of which the second phase (P2) consists, at least one further element.

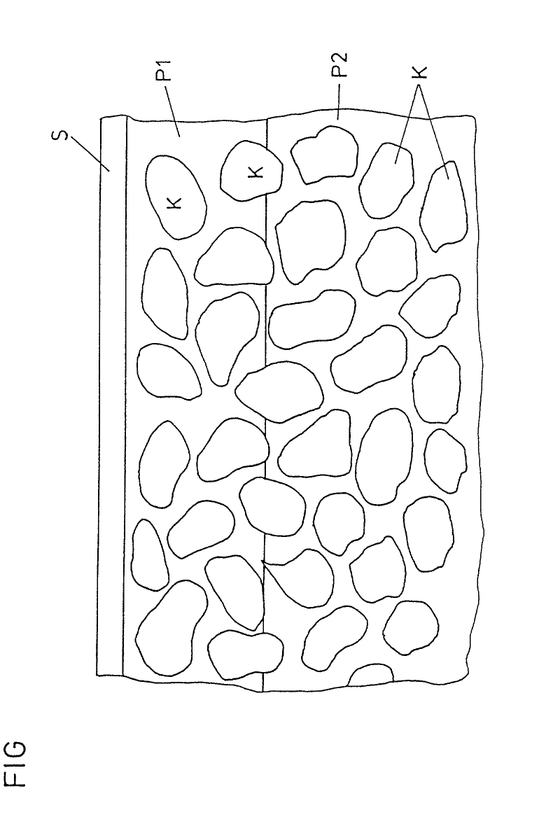

### BACKGROUND OF THE INVENTION

The invention concerns a magnet largely consisting of material which corrodes easily. Furthermore, the invention concerns a process for the production of this type of magnet.

This type of magnet is, for example, described in DE 3 902 480 A1. This is a neodymium-boron-iron magnet which is provided with a zinc phosphate coating for protection against corrosion. The neodymium-boron-iron magnet has hard magnetic grains which are composed of neodymium, boron, and iron. The hard magnetic grains are separated from one another by a non-magnetic phase for magnetic insulation. This phase largely consists of neodymium and corrodes very easily. However, due to the coating, the magnet is corrosion resistant, in spite of the easily corroding non-magnetic phase. The effectiveness of the coating depends decisively on the compactness and adhesion of the coating during its production and on possible later mechanical stresses.

### DETAILED DESCRIPTION OF THE INVENTION

The invention has as its object the specification of a magnet which is, after mechanical stress, more resistant to corrosion than the prior art. Furthermore, a process for the production of this type of magnet is to be specified.

This object is achieved by a magnet having hard magnetic grains. The hard magnetic grains which are in a surface layer of the magnet are separated from one another by a first phase. The hard magnetic grains which are in the remainder of the magnet are separated from one another by a non-magnetic second phase. The first phase is more corrosion resistant than the second phase. The first phase has, in addition to the elements of which the second phase consists, at least one further element. The further element increases the corrosion resistance of the first phase relative to the second phase.

Because the first phase is located in the surface layer of the magnet and is more corrosion resistant than the second phase, the first phase serves for protection from corrosion. On one hand, the first phase protects the hard magnetic grains and, on the other hand, the first phase protects the second phase, which is located inside the magnet. The surface layer thus forms a corrosion protection layer. Because the surface layer is part of the magnet, the surface layer, which acts as an anticorrosive, is permanently bonded with the rest of the magnet and does not come off, even under mechanical stress.

This type of magnet can, for example, be produced with the following process, which also achieves the object:

The magnet is initially produced in such a way that all of its hard magnetic grains are separated from one another by the second phase. Subsequently, a material consisting of, or comprising, at least the further element is applied to a surface of the magnet. After the application of the material, a heat treatment is performed at a temperature at which the second phase melts and mixes with at least a part of the material so that the second phase is replaced by the first phase in the surface layer of the magnet. Due to the mixing, the first phase has both the elements of the second phase and the further element, which stems from the applied material.

The first phase can have additional elements if parts of the hard magnetic grains are dissolved by the heat treatment and mix with the fluid second phase.

The material can be applied so thinly that, after the heat treatment, the material is completely integrated into the first phase.

The material can be applied so thinly that it does not form a continuous film and does not completely cover the surface of the magnet.

The material is preferably deposited as a film which is thick enough that a part of the film remains after the heat treatment. In this case, after the heat treatment, the magnet is coated with the film, which borders the surface layer. The film offers additional protection against corrosion. In particular, oxidation of the hard magnetic grains can be prevented by the film.

The film made of the material can, for example, be between 1 μm and 20 μm thick.

The film can be applied with physical methods, such as through PVD (physical vapor deposition) or sputtering. Alternatively, the layer can be mechanically applied through, for example, rubbing, sandblasting, or tumbling, or galvanically.

The heat treatment is preferably performed at a temperature below the melting temperature of the material, because, during the reaction of the fluid material with the hard magnetic grains, undesired reactions which form harmful soft magnetic phases could occur.

The process according to the invention is particularly advantageous if the magnet is shaped by mechanical processing and subsequently the material is applied and the heat treatment is performed. As a rule, cracks and pores which lead to mechanical instability occur due to the mechanical processing. If, however, the heat treatment is performed after the mechanical processing, the cracks and pores are filled by the first phase, which is formed from the fluid second phase and additives, so that the magnet is compacted and mechanically stabilized.

The hard magnetic grains can, for example, consist of at least SE, iron, and boron, with SE standing for one or more rare earths. It has been shown that the first phase is particularly corrosion resistant if it has a composition which essentially consists of the formula SE₆T₁₄₋ₓMₓ, with T standing for one or more transition metals, but at least for iron, M being the further element, and x≧1. The further element is selected in such a way that the first phase has a composition in accordance with the formula mentioned above. Al, Si, Cu, Ga, Sn, and Bi are, for example, suitable as the further element.

The iron in the first phase comes largely from the hard magnetic grains. For this purpose, the heat treatment is performed at a temperature at which the parts of the hard magnetic grains are dissolved in such a way that the first phase contains iron which comes from the hard magnetic grains.

The heat treatment is, for example, performed at between 450° C. and 650° C.

The first phase consists of, or comprises, for example, between 25 atomic % and 35 atomic % SE and between 5 atomic % and 20 atomic % M. It has been shown that with this type of composition, the corrosion resistance of the first phase is particularly high.

The surface layer is, for example, between 10 μm and 100 μm thick.

The hard magnetic grains preferably have a diameter of between 5 and 50 μm. The hard magnetic grains preferably occupy more than 90% of the volume of the magnet.

In the following, an exemplary embodiment of the invention is described in more detail with reference to the figure.

A magnet made of Nd—Fe—B is produced with the typical powder metallurgy method through grinding of a molten alloy until a particle size of approximately 3 μm is achieved, compression in an orienting magnetic field, and subsequent sintering in the temperature range from 900° C. to 1100° C. for 1 to 4 h. After a surface treatment through grinding, tumbling, and pickling, a film S of approximately 20 μm made of aluminum is applied to the surface of the magnet through a PVD process.

A subsequent heat treatment in the temperature range between 480° C. and 530° C. for 3 h leads to a reaction of a Nd-rich second phase P2 (see FIG. ), located between the hard magnetic grains K, with aluminum from the film S, and to formation of a first phase P1 with the composition Nd₄Fe₁₄₋ₓAlₓ (with x between 1 and 7). The iron portion in the first phase PI hereby stems from the partially dissolved hard magnetic grains K. This Nd-poorer first phase P1 replaces the Nd-rich second phase P2 in a seam which encloses a few layers of grains on the surface. Existing cracks from the mechanical processing and gaping grain boundaries from the pickling treatment are also hereby closed by the first phase PI, which develops during the heat treatment. Because the first phase P1 develops in the entire surface seam and replaces the Nd-rich second phase P2, which is susceptible to corrosion, the corrosion resistance of the magnet treated in this way is improved by a factor of more than 10 in a HAST test (Highly Accelerated Stress Test, water steam at 130° C./2.7 bar) relative to the magnet without the treatment.

We claim:

1. A magnet,
having hard magnetic grains (K), characterized in that
the hard magnetic grains (K) are separated from one another in a surface layer of the magnet by a first phase (P1),
the hard magnetic grains (K) are separated from one another in the remaining part of the magnet by a nonmagnetic second phase (P2), with the first phase (P1) more corrosion resistant than the second phase (P2),
the first phase (P1) has, in addition to the elements of which the second phase (P2) is comprised, at least one further element.

2. A magnet according to claim 1,
wherein the first phase (P1) has a composition which essentially consists of the formula
SE₆T₁₄₋ₓMₓ
with SE standing for one or more rare earths, T standing for one or more transition metals, but at least iron, M being the further element, and x≧1,
wherein the hard magnetic grains (K) consist of at least SE, iron, and boron.

3. A magnet according to claim 2,
wherein SE stands for Nd, Pr, and/or Dy,
wherein M stands for Al, Si, Cu, Ga, Sn, and/or Bi.

4. A magnet according to claim 2,
wherein the second phase (P2) consists of more than 70 atomic % SE,
wherein the first phase (P1) consists of between 25 atomic % and 35 atomic % SE and between 5 atomic % and 20 atomic % M.

5. A magnet according to claim 1,
wherein the surface layer is between 10 μm and 100 μm thick.

6. A magnet according to claim 1,
wherein the magnet is coated with a film (S) which borders the surface layer and at least comprises the at least one further element.

7. A process for the production of the magnet,
wherein the magnet is initially produced in such a way that it has hard magnetic grains (K) which are separated from one another by a second nonmagnetic phase (P2), which comprises specific elements,
wherein a material is subsequently applied which comprises at least one further element, which is different from the elements of which the second phase (P2) is comprised,
wherein, after the application of the material, a heat treatment is performed at a temperature at which the second phase (P2) melts and mixes with at least a part of the material in such a way that, in a surface layer of the magnet, the second phase (P2) is replaced by a first phase (P1), which, in addition to the elements of which the second phase is comprised, has at least the one further element and is more corrosion resistant than the second phase (P2).

8. A process according to claim 7,
wherein the magnet is shaped through mechanical processing and the material is subsequently applied.

9. A process according to claim 7,
wherein the material is applied in a thickness such that it forms a film (S).

10. A process according to claim 7,
wherein the hard magnetic grains (K) are produced from at least iron, boron, and a rare earth,
wherein the second phase (P2) is produced in such a way that it comprises more than 70 atomic % of the rare earth,
wherein the further element is Al, Si, Cu, Ga, Sn, and/or Bi,
wherein the heat treatment is performed at a temperature at which the parts of the hard magnetic grains (K) are dissolved in such a way that the first phase (P1) contains iron which comes from the hard magnetic grains (K).

11. A process according to claim 10,
wherein the heat treatment is performed at between 450° C. and 600° C.
